(19) United States
(12) Patent Application Publication
(10) Pub. No.: US 2025/0232214 A1
(43) Pub. Date: Jul. 17, 2025

(54) METHOD, DEVICE, MEDIUM, AND PROGRAM PRODUCT FOR TRAINING QUESTION-ANSWER SYSTEM

(71) Applicant: Dell Products L.P., Round Rock, TX (US)

(72) Inventors: Zijia Wang, Weifang (CN); Zhisong Liu, Shenzhen (CN); Zhen Jia, Shanghai (CN); Jiacheng Ni, Shanghai (CN)

(21) Appl. No.: 18/436,346

(22) Filed: Feb. 8, 2024

(30) Foreign Application Priority Data
Jan. 12, 2024 (CN) 202410055105.0

(51) Int. Cl. G06N 20/00

(52) U.S. Cl. CPC G06N 20/00

(57) ABSTRACT

Embodiments of the present disclosure relate to a method, a device, a medium, and a program product for training a question-answer system. The method includes: determining a distribution of hidden variables in a variational language model based on a query in a training data set. The method further includes: generating a plurality of answers for the query using the variational language model based on a plurality of hidden variables randomly sampled from the distribution. The method further includes: determining reward scores for the plurality of answers using a reward model. The method further includes: updating the variational language model based on the query and the best answer with the highest reward score among the plurality of answers.

### RELATED APPLICATION

The present application claims priority to Chinese Patent Application No. 202410055105.0, filed Jan. 12, 2024, and entitled “Method, Device, Medium, and Program Product for Training Question-Answer System,” which is incorporated by reference herein in its entirety.

### FIELD

Embodiments of the present disclosure generally relate to the technical field of computers, and specifically relate to a method, an electronic device, a medium, and a computer program product for training a question-answer system.

### BACKGROUND

With the development of computer technology, intelligent question-answer services such as chatbots and virtual assistants have become increasingly widespread. However, existing intelligent question-answer services have a number of problems. For example, they may generate answers that do not meet human preferences and values. In addition, the answers generated by intelligent question-answer services trained through language models are often too general and boring, lacking problem specificity.

In order to improve the user experience of intelligent question-answer services, there is an urgent need for techniques that can generate answers meeting human preferences and values and also make answers more targeted to meet different needs of users.

### SUMMARY

Embodiments of the present disclosure provide a method, an electronic device, a medium, and a computer program product for training a question-answer system. According to the technical solution provided by the present disclosure, answers which meet human values and preferences and are better targeted to questions can be generated. Therefore, the user experience of intelligent question-answer systems is improved.

In a first aspect, the present disclosure provides a method for training a question-answer system. The method includes: determining a distribution of hidden variables in a variational language model based on a query in a training data set. The method further includes: generating a plurality of answers for the query using the variational language model based on a plurality of hidden variables randomly sampled from the distribution. The method further includes: determining reward scores for the plurality of answers using a reward model. The method further includes: updating the variational language model based on the query and the best answer with the highest reward score among the plurality of answers.

In a second aspect, the present disclosure provides an electronic device, including: at least one processor; and a memory coupled to the at least one processor and having instructions stored therein, wherein the instructions, when executed by the at least one processor, cause the electronic device to perform the method in the first aspect of the present disclosure.

In a third aspect, the present disclosure provides a non-transitory computer-readable storage medium having machine-executable instructions stored thereon, and the machine-executable instructions, when executed by a machine, cause the machine to implement the method in the first aspect of the present disclosure.

In a fourth aspect, the present disclosure provides a computer program product tangibly stored on a non-transitory computer-readable medium and including machine-executable instructions, where the machine-executable instructions, when executed by a machine, cause the machine to implement the method in the first aspect of the present disclosure.

It is to be understood that the content described in the present section is neither intended to identify key or essential features of embodiments of the present disclosure, nor intended to limit the scope of the present disclosure. Other features of the present disclosure will become readily understandable from the Detailed Description below.

### BRIEF DESCRIPTION OF THE DRAWINGS

By additional description of example embodiments of the present disclosure, provided in more detail herein with reference to the accompanying drawings, the above and other objectives, features, and advantages of the present disclosure will become more apparent. Identical reference numerals generally represent identical components in the example embodiments of the present disclosure, in which:

FIG. 1 is a block diagram of an environment for training a question-answer system according to an embodiment of the present disclosure;

FIG. 2 is a flow chart of a method for updating a variational language model according to an embodiment of the present disclosure;

FIG. 3 is a flow chart of a method for generating a plurality of answers using a variational language model according to an embodiment of the present disclosure;

FIG. 4 is a flow chart of a method for updating model parameters according to an embodiment of the present disclosure; and

FIG. 5 is a block diagram of an electronic device according to an embodiment of the present disclosure.

### DETAILED DESCRIPTION

Illustrative embodiments of the present disclosure will be described below in further detail with reference to the accompanying drawings. Although the accompanying drawings show some embodiments of the present disclosure, it is to be understood that the present disclosure may be implemented in various forms, and should not be construed as being limited to the embodiments stated herein. Rather, these embodiments are provided for understanding the present disclosure more thoroughly and completely. It is to be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As used herein, a “model” can learn a correlation between corresponding inputs and outputs from training data, so that a corresponding output may be generated for a given input after the training is completed. The generation of a model may be based on machine learning technologies. Deep learning is a machine learning algorithm that uses multiple layers of processing units to process inputs and provide corresponding outputs. The neural network model is an example of a model based on deep learning. Here, “model” may also be referred to as “machine learning model,” “learning model,” “machine learning network,” or “learning network,” and these terms are used interchangeably herein.

A neural network is illustratively a machine learning network based on deep learning. A neural network is capable of processing an input and providing a corresponding output, and generally includes an input layer, an output layer, and one or more hidden layers between the input layer and the output layer. The neural network used in a deep learning application usually includes many hidden layers, thereby increasing the depth of the network. Layers of a neural network are connected in sequence, so that an output from one layer is provided as an input to a next layer, where the input layer receives an input to the neural network, and an output from the output layer is used as a final output from the neural network. Each layer of the neural network includes one or more nodes (also referred to as processing nodes or neurons), and each node processes an input from the last layer.

Usually, machine learning may roughly include three stages, namely, a training stage, a testing stage, and a usage stage (also referred to as a reasoning stage). In the training stage, a given model may be trained using a large amount of training data, and the parameter values are continuously iterated and updated until the model can obtain, from the training data, consistent inferences that meet the expected target. Through training, the model can be considered to be able to learn the correlation between inputs and outputs (also referred to as mapping from inputs to outputs) from the training data. Parameter values of the trained model are determined. In the testing stage, test inputs are applied to the trained model to test whether the model can provide correct outputs, thereby determining the performance of the model. In some embodiments, the testing stage may be omitted. In the usage stage, the model may be used for processing an actual input based on the parameter values obtained by training and determining a corresponding output.

As described above, intelligent question-answer services have a number of problems. For example, they may generate answers that do not meet human preferences and values. In addition, the answers generated by intelligent question-answer services trained through language models are often too general and boring, lacking specificity. Because existing intelligent question-answer services are generally trained based on language models, while language models cannot acquire the features such as preference and value choices of users, the generated answers may not meet human values and preferences. In addition, existing language models cannot generate diverse answers or select the most suitable answer for output to a user, leading to low quality of the answers. For example, when a user initiates a query for inquiring an intelligent question-answer service, such as, “Can technology A be applied to industry B,” the answers generated by the intelligent question-answer service may be: “What exactly is technology A” and “What exactly is industry B.” In such an arrangement, a clear answer cannot be given to the user, and the answers are not targeted to the question.

In order to at least solve the above and other potential problems, an embodiment of the present disclosure provides a method for training a question-answer system. In the method, a new architecture based on reinforcement learning and variational inference is provided; the architecture in some embodiments includes three parts: the first part is a variational language model, through which diverse answers are generated. The second part is a reward model, through which a human feedback mechanism is introduced to evaluate the quality of different answers generated by the variational language model and to select and output the answer with the highest reward score. The third part is a strategy gradient update module, which updates the parameters of the variational language model based on the maximized reward score of the answers. In this way, the answers outputted by the question-answer system can be caused to meet human values and preferences; and meanwhile, the generated answers are more targeted, more helpful answers can be provided to users, and the user experience of the intelligent question-answer service is improved. Embodiments of the present disclosure will be further described in detail below in conjunction with the accompanying drawings.

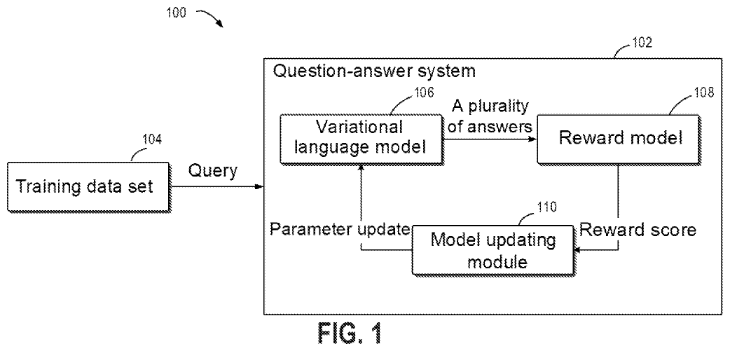

FIG. 1 is a block diagram of an environment for training a question-answer system according to an embodiment of the present disclosure. As shown in FIG. 1, an environment 100 includes a training data set 104 required for training a variational language model 106, and a question-answer system 102. The question-answer system 102 further includes three parts, namely, the first part refers to the variational language model 106, the second part refers to a reward model 108, and the third part refers to a model updating module 110. In some embodiments, the training data set 104 may be a Persona-Chat data set or a CoQA data set. Firstly, the training data set 104 is used for pre-training the variational language model 106. Then, after the pre-training is finished, a plurality of answers outputted by the variational language model 106 are acquired based on a new input. In order to evaluate the quality of the answers generated by the variational language model 106, the reward model 108 is used for generating a reward value or a reward score for each answer. In some embodiments, the generated reward score is a scalar. The answer with the highest answer quality is selected according to the reward scores. Finally, the model updating module 110 is used for updating parameters of the variational language model 106 according to the reward score conditions.

In some embodiments, the variational language model 106 may generate a plurality of answers based on a user query and hidden variables. In statistics, the hidden variables, as opposed to observable variables, refer to unobservable random variables that can be inferred from observed data through a mathematical model. The uncertainty and variability in the answer generation process may be measured through the hidden variables. In some embodiments, the uncertainty and variability may be the tone and style of the user query and content of the answer. In some embodiments, the variational language model 106 may infer the tone and style of the user query and content of the answer from the text inputted by the user.

In some embodiments, the variational language model 106 may be a conditional variational auto-encoder. The conditional variational auto-encoder includes two parts: the first part refers to an encoder part, and the second part refers to a decoder part. The hidden variables of the query may be acquired by the encoder based on the user query; and after the hidden variables are acquired, an answer for the query may be acquired by the decoder part based on the user query and the hidden variables. Specifically, the encoder in the variational auto-encoder will convert all the feature information distributions carried by the inputted user query into Gaussian distributions which may be considered as hidden variables. Then, the hidden variables, the user query, and the already generated answer characters are inputted to the decoder to acquire an answer for the query.

In some embodiments, the reward model 108 may be a neural network model based on human feedback. Human feedback may be explicit or indirectly indicated. For example, explicit human feedback may be a direct rating or scoring of a human being to an answer generated by the variational language model 106. Indirectly indicated human feedback may be an indirect signal reflecting human preferences and values, such as user click-through rate, dwell time, or emotion analysis. In some embodiments, the user query and the generated corresponding answer are inputted to the reward model 108, and the reward model 108 may output a reward score that measures the quality of the answer.

In some embodiments, the model updating module 110 may be an evaluation algorithm. This algorithm may optimize the parameters of the variational language model 106 based on the user query and the corresponding answer and reward score, so that the answer outputted by the question-answer system 102 meets the user needs.

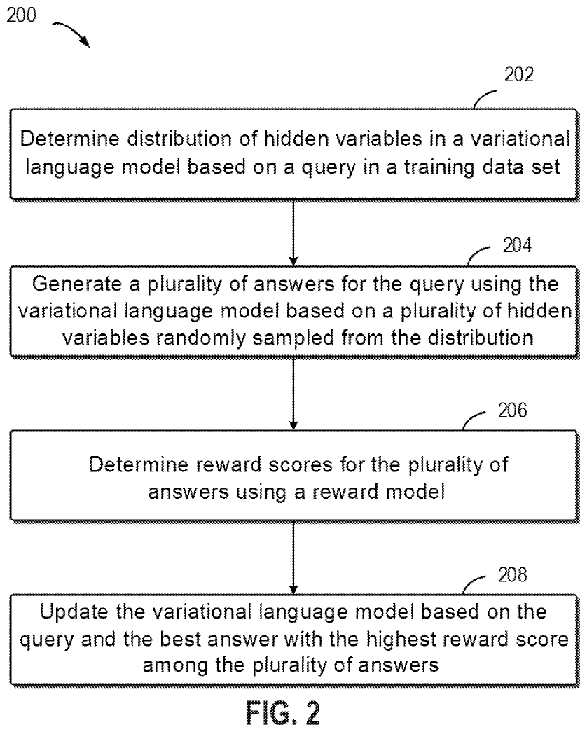

FIG. 2 is a flow chart of a method 200 for updating a variational language model according to an embodiment of the present disclosure. In some embodiments, the method 200 may be implemented by, for example, the question-answer system 102 shown in FIG. 1. It is to be understood that the method 200 may also include additional actions not shown and/or may omit actions shown, and the scope of the present disclosure is not limited in this regard.

As shown in FIG. 2, at block 202, a distribution of hidden variables in the variational language model 106 is determined based on a query in a training data set. In some embodiments, it may be assumed that the hidden variables have a multivariate Gaussian distribution. Based on a given query in the training data set, the mean and variance of the query are generated using the variational language model 106, and the probability distribution (e.g., a multivariate Gaussian distribution) of the hidden variables is determined based on the mean and variance of the query.

At block 204, a plurality of answers for the query are generated using the variational language model based on a plurality of hidden variables randomly sampled from the distribution. In some embodiments, a query is given, and then a numerical value in the distribution of hidden variables is randomly sampled. Based on this numerical value, an answer for the query is generated using the variational language model 106. The above step is performed multiple times to acquire a plurality of randomly sampled hidden variables, and a plurality of answers can be generated based on the plurality of randomly sampled hidden variables.

At block 206, reward scores for the plurality of answers are determined using the reward model 108. In some embodiments, the reward model evaluates the plurality of answers based on human feedback. The evaluation may be rating or scoring, or an indirect evaluation index based on click-through rate, dwell time, or the like, which is not limited here.

At block 208, the variational language model 106 is updated based on the query and the best answer with the highest reward score among the plurality of answers. In some embodiments, the variational language model 106 is updated based on a given query, the answer corresponding to the given query, and the reward score of the answer.

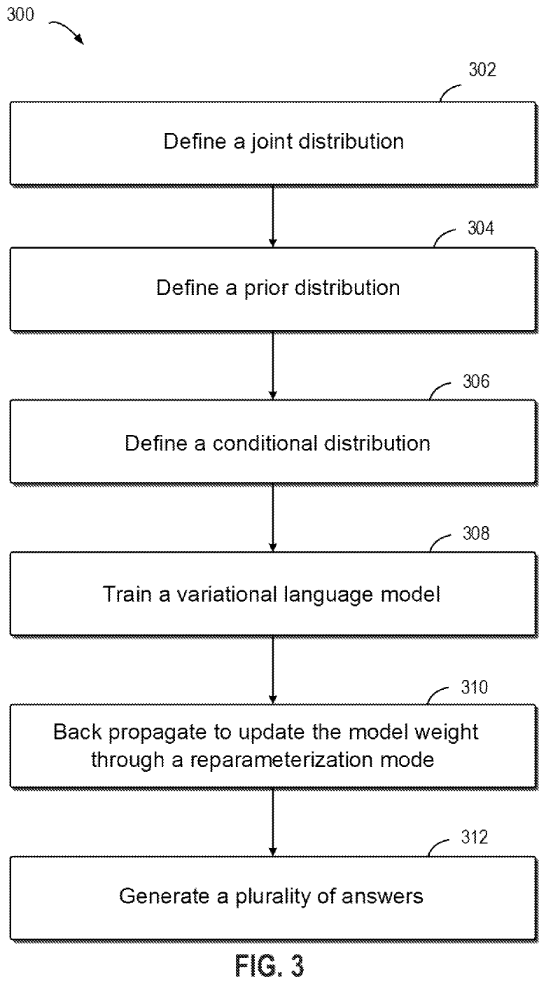

FIG. 3 is a flow chart of a method 300 for generating a plurality of answers using a variational language model according to an embodiment of the present disclosure. The method 300 of FIG. 3 shows specific implementation steps of block 204, and the process of generating a plurality of answers based on a given query will be described in detail below in combination with FIG. 3.

As shown in FIG. 3, and as indicated above, the method 300 of generating a plurality of answers is a specific implementation of block 204 in FIG. 2, and the method may be executed on, for example, the variational language model 106 in FIG. 1 or any suitable computing device or server.

In order to generate a plurality of answers, firstly, it is needed to pre-train a variational language model. Specifically, at block 302, a joint distribution is defined:

$${p}_{θ} ( a , z \vert q ) = {p}_{θ} ( a \vert z , q ) {p}_{θ} ( z \vert q ) \qquad ( 1 )$$

where q represents a user query, a represents an answer generated for the query, z represents a hidden variable, and θ represents a model parameter of the variational language model. The joint distribution formula may be considered as a variant of Bayesian estimation. Based on this formula, the probability distribution of the hidden variable z may be acquired with the given q. Then, the a for the query may be acquired based on the hidden variable z and the given q. Finally, the joint distribution may be acquired based on the z, q, and a.

At block 304, the probability distribution of the hidden variable z is defined as a prior distribution. In some embodiments, the hidden variable z may be considered as a multivariate Gaussian distribution, and may be a matrix with diagonal covariance:

$${p}_{θ} ( z \vert q ) = ( z ; {μ}_{θ} ( q ) , {σ}_{θ} ( q ) ) \qquad ( 2 )$$

where μ_{θ}(q) and σ_{θ}(q) respectively represent the mean and variance of the multivariate Gaussian distribution. In some embodiments, the given q is inputted to the encoder of the variational language model to acquire a mean and a variance of the multivariate Gaussian distribution, respectively.

At block 306, a conditional distribution is defined, and an answer is generated based on this conditional distribution. Specifically, the current answer characters are generated based on the already generated answer characters, the hidden variable, and the given query:

$${p}_{θ} ( a \vert z , q ) = {\prod }_{t = 1}^{T} {p}_{θ} ( {a}_{t} \vert {a}_{< t} , z , q ) \qquad ( 3 )$$

where T represents the character length of the answer. For example, if the answer is “A technology can be applied to B industry,” the length of T is 11. aₜ refers to the current answer characters. In some embodiments, the decoder in the variational language model may generate the current answer characters based on the already generated answer characters, the hidden variable z, and the given query q, and then form a complete answer based on the generated answer characters. In some embodiments, the decoder in the variational language model may be implemented by any form of autoregressive model. For example, it can be a Recurrent Neural Network (RNN) or a Transformer neural network.

At block 308, the variational language model is pre-trained. In some embodiments, the training of the variational language model may be performed by a method of maximizing an evidence lower bound, sometimes referred to as an ELBO, illustratively given by:

$$ℒ ( θ , ϕ ; q , a ) = 𝔼 q ϕ ( z \vert q , a ) [ log {p}_{θ} ( a \vert z , q ) ] - KL ( {q}_{ϕ} ( z \vert q , a ) ‖ {p}_{θ} ( z \vert q ) ) \qquad ( 4 )$$

where ϕ represents model parameters of the inference network, and q_{ϕ}(z|q, a) represents a probability distribution introduced based on the method of variational inference, and is used for approximately estimating the posterior probability p_{θ}(z|q, a) which is difficult to calculate, that is:

$${q}_{ϕ} ( z \vert q , a ) = ( z ; {μ}_{ϕ} ( q , a ) , {σ}_{ϕ} ( q , a ) ) \qquad ( 5 )$$

where the mean μ_{ϕ}(q, a) and the variance σ_{ϕ}(q, a) in the posterior probability are generated by inputting the given query q and the generated answer a as inputs into the inference network. In some embodiments, the model parameters of the inference network may be consistent with the model parameters of the variational language model, and optimal model parameters may also be acquired by pre-training the inference network.

In Formula (4) of maximizing the evidence lower bound, the similarity between the distributions q_{ϕ}(z|q, a) and p_{θ}(z|q) is measured through Kullback-Leibler (KL) divergence. Maximizing the evidence lower bound refers to maximizing log likelihood of the generated answer, that is, maximizing the expected value of log p_{θ}(a|z, q) based on q_{ϕ}(z|q, a). The variational language model is pre-trained by the training method of maximizing the evidence lower bound.

After the pre-training is finished, the variational language model is back propagated to update a model weight. At block 310, back propagating is performed through the following reparameterization mode to update the model weight:

$$z = {μ}_{ϕ} ( q , a ) + {σ}_{ϕ} ( q , a ) ⊙ ϵ \qquad ( 6 )$$

where ϵ˜N(0, l) refers to a random noise vector, and ⊙ represents a product of corresponding position elements of two matrices. By this method, the hidden variable can be converted into a differentiable form, and then back propagating is performed by a chain rule to update the model weight.

After the pre-training process is finished, at block 312, a plurality of answers are generated through the variational language model after being pre-trained. For the given query q, a numerical value is first randomly sampled from the hidden variable distribution:

$$z ∼ {p}_{θ} ( z \vert q ) = ( z ; {μ}_{θ} ( q ) , {σ}_{θ} ( q ) ) \qquad ( 7 )$$

where a hidden variable is randomly sampled from the hidden variable distribution (e.g., a multivariate Gaussian distribution). The hidden variable is taken as an input to generate current answer characters:

$$a ∼ {p}_{θ} ( a \vert z , q ) = {\prod }_{t = 1}^{T} {p}_{θ} ( {a}_{t} \vert {a}_{< t} , z , q ) \qquad ( 8 )$$

where the current answer characters are generated based on the already generated answer characters, the numerical value randomly sampled from the hidden variable distribution, and the given query q, and then a complete answer is obtained based on the generated answer characters. In some embodiments, diverse answers may be generated based on a beam search with a diversity penalty function. In some embodiments, a numerical value may be continuously sampled from the hidden variable distribution, the current answer characters are generated based on the numerical value, the given query q, and the already generated answer characters, and then a new answer is generated. And then, diverse answers are generated by the beam search with the diversity penalty function; and by continuously implementing the above-mentioned method, a plurality of diverse answers may be generated.

In some embodiments, the reward model may be used for selecting the answer with the highest quality. The reward model may be considered as a classifier, that is, the given query and the generated answer are taken as the model inputs, and a reward score is outputted to measure the quality of the answer.

The query is defined as q, the answer is defined as a, and the reward model may map q and a into a scalar:

$${r}_{ψ} ( a \vert q ) = {f}_{ψ} ( q , a ) \qquad ( 9 )$$

where ψ represents a model parameter of the reward model, and f_{ψ} may represent a neural network, for example, a Multilayer Perceptron (MLP) or a Transformer network. The neural network may use human feedback data for supervised learning. In some embodiments, the human feedback data may be collected online or offline, which is not limited here. The data collected online may be the data fed back to the system in real time when a user uses the question-answer system online. The data collected offline may be the data that a human annotator scores the collected question-answer data in advance. In some embodiments, the reward model may perform self-supervised training using data that indirectly indicates the human scoring, which may be, for example, the click-through rate, dwell time, or emotion analysis of the user.

After the training of the reward model is finished, the reward model may score the plurality of answers generated by the variational language model and screen out the answer with the highest reward score:

$${a}^{*} {=}_{a ∈} {r}_{ψ} ( a \vert q ) \qquad ( 10 )$$

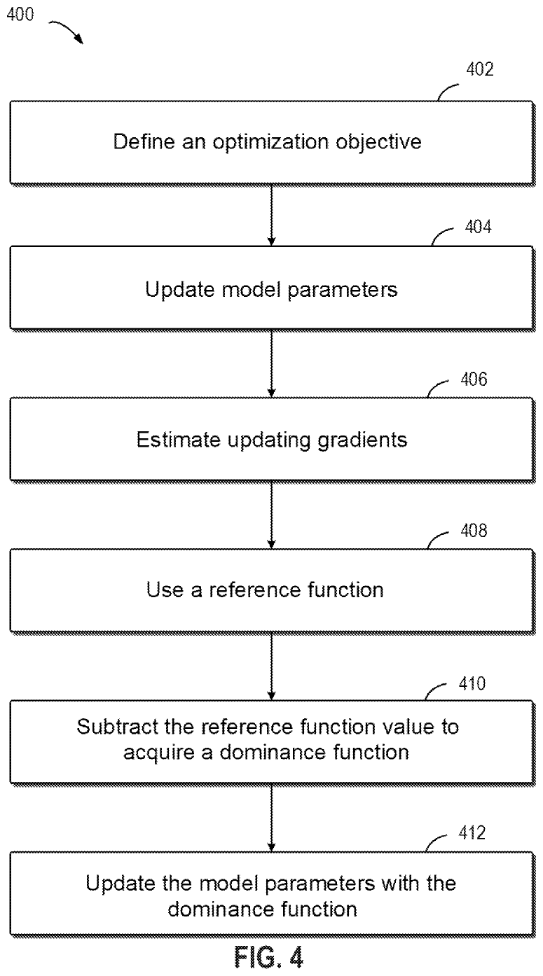

In some embodiments, the best answer a* screened out by the reward model may be used in the model updating module to update the parameters of the variational language model, which will be specifically described in combination with FIG. 4 below.

FIG. 4 is a flow chart of a method 400 for updating model parameters according to an embodiment of the present disclosure. The method 400 refers to specific implementation steps of block 208, and the process of updating the variational language model based on the query and the best answer with the highest reward score among the plurality of answers is described in detail below in combination with FIG. 4.

At block 402, an optimization objective is defined. In some embodiments, the model parameters of the variational language model and the model parameters of the reward model are updated using a strategy gradient algorithm. The objective of the strategy gradient algorithm is to maximize the reward score outputted by the reward model, that is:

$$J ( θ , ψ ) = 𝔼 p θ ( a \vert q ) [ {r}_{ψ} ( a \vert q ) ] \qquad ( 11 )$$

where after the answer a is generated based on the given query q, the expectation of the reward score generated by the reward model is acquired. At a block 404, the model parameters are updated based on the Formulas (12) and (13):

$$θ ← θ + α {∇}_{θ} J ( θ , ψ ) \qquad ( 12 )$$

$$ψ ← ψ + β {∇}_{ψ} J ( θ , ψ ) \qquad ( 13 )$$

where ∇_{θ}J(θ, ψ) and ∇_{ψ}J(θ, ψ) respectively represent updating gradients of the model parameters. At block 406, the updating gradients are estimated:

$${∇}_{θ} J ( θ , ψ ) \approx \frac{1}{N} {\sum }_{n = 1}^{N} {r}_{ψ} ( a ( n ) \vert q ( n ) ) {∇}_{θ} log {p}_{θ} ( a ( n ) \vert q ( n ) ) \qquad ( 14 )$$

$${∇}_{ψ} J ( θ , ψ ) \approx \frac{1}{N} {\sum }_{n = 1}^{N} {r}_{ψ} ( a ( n ) \vert q ( n ) ) {∇}_{ψ} {r}_{ψ} ( a ( n ) \vert q ( n ) ) \qquad ( 15 )$$

In some embodiments, the parameters of the variational language model and the reward model may be updated using a gradient-rising method. q⁽ⁿ⁾ and a⁽ⁿ⁾ in Formulas (14) and (15) may be a pair of query and corresponding answer randomly sampled from the variational language model.

At block 408, a reference function is used. Specifically, in order to reduce the variance of gradient estimation, the reference function may be used for estimating an expected value of a given query:

$${b}_{ψ} ( q ) = 𝔼 p θ ( a \vert q ) [ {r}_{ψ} ( a \vert q ) ] \qquad ( 16 )$$

In some embodiments, another different language model may be used for generating an answer a for a randomly given query q. In some embodiments, the variational language model may also be used for randomly generating an answer a for the given query q, which is not limited here. In some embodiments, the given query q and the generated answer a may be used as inputs to the Formula (4) for training the variational language model. In some embodiments, Formula (16) may share model parameters with the reward model or acquire a model parameter by pre-training.

After the randomly given query q and the answer a for the query are acquired, another answer a is generated using the variational language model. In some embodiments, the given query q may be consistent with the query q during acquiring the reference function value, or another query q may be given. Based on the query q, a new reward score is acquired.

At block 410, the reference function value is subtracted to acquire a dominance function. The acquired reference function value is subtracted from the reward score to acquire a dominance function value, that is:

$${A}_{ψ} ( a \vert q ) = {r}_{ψ} ( a \vert q ) - {b}_{ψ} ( q ) \qquad ( 17 )$$

Formula (17) is the dominance function that measures the difference between the continuously generated answer and the reference answer, and the difference is used for evaluating the quality of the answer. In some embodiments, a dominance function value is acquired by subtracting the reference function value from the reward score of the answer generated using the variational language model. The dominance function value is substituted into Formula (11), and then the model parameters of the variational language model and the model parameters of the reward model are updated separately based on the gradient update formula.

At block 412, the model parameters are updated with the dominance function. That is:

$$θ ← θ + α {∇}_{θ} J ( θ , ψ ) \qquad ( 18 )$$

$$ψ ← ψ + β {∇}_{ψ} J ( θ , ψ ) + γ {∇}_{ψ} {b}_{ψ} ( q ) \qquad ( 19 )$$

where γ in Formula (19) represents the learning rate, and the last item γ∇_{ψ}b_{ψ}(q) is used for keeping the reference function consistent with the reward function.

Example embodiments of the present disclosure are described above with reference to FIG. 1 to FIG. 4. Compared with the existing solutions, the method for training a question-answer system for a user according to the present disclosure may generate more diverse and targeted answers, which avoids generating general and boring answers, and improves the user interaction experience. On the other hand, the answers generated by the method according to the present disclosure better meet the human values and preferences, thereby more effectively realizing “AI alignment.” Specifically, the present disclosure provides a new architecture, including the variational language model, the reward model, and the strategy gradient updating module. By introducing the hidden variables, the variational language model may generate diverse answers. By introducing the human feedback mechanism, the reward model may screen out the answers meeting human values and preferences, which realizes the quality evaluation of different answers generated by the variational language model and selects and outputs the answer with the highest reward score. The strategy gradient updating module updates the parameters of the variational language model based on the maximized reward score of the answers, which improves the performance and robustness of the model.

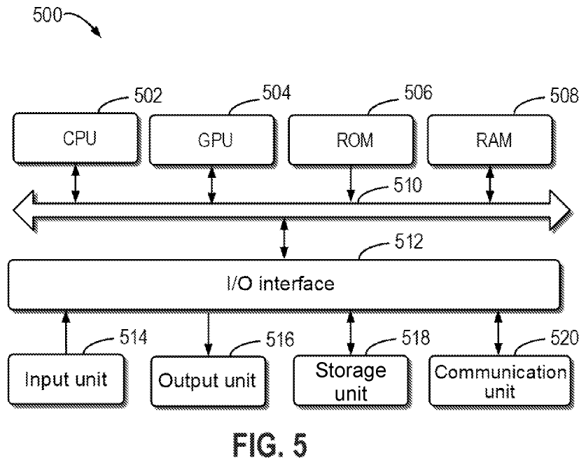

FIG. 5 is a block diagram of a device 500 according to some embodiments of the present disclosure. The device 500 is an example of what is more generally referred to herein as an electronic device. As shown in FIG. 5, the device 500 includes a central processing unit (CPU) 502 and a graphics processing unit (GPU) 504, which may perform various appropriate actions and processing according to computer program instructions stored in a read-only memory (ROM) 506 or computer program instructions loaded from a storage unit 518 to a random access memory (RAM) 508. Various programs and data required for the operation of the device 500 may also be stored in RAM 508. The CPU 502, the GPU 504, the ROM 506, and the RAM 508 are connected to each other through a bus 510. An input/output (I/O) interface 512 is also connected to the bus 510. Although not shown in FIG. 5, the device 500 may also include a co-processor.

A plurality of components in the device 500 are connected to the I/O interface 512, including: an input unit 514, such as a keyboard and a mouse; an output unit 516, such as various types of displays and speakers; the storage unit 518, such as a magnetic disk and an optical disc; and a communication unit 520, such as a network card, a modem, and a wireless communication transceiver. The communication unit 520 allows the device 500 to exchange information/data with other devices via a computer network, such as the Internet, and/or various telecommunication networks.

The various methods or processes described above may be executed by the CPU 502 and the GPU 504. For example, in some embodiments, the method may be implemented as a computer software program that is tangibly included in a machine-readable medium, such as the storage unit 518. In some embodiments, part of or all the computer program may be loaded and/or installed to the device 500 via the ROM 506 and/or the communication unit 520. When the computer program is loaded and executed by the CPU 502 and the GPU 504, one or more steps or actions of the method or process described above may be performed.

Various embodiments of the systems and techniques described herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or combinations thereof. These and other embodiments may be implemented in one or more computer programs which can be executed and/or interpreted on a programmable system including at least one programmable processor, and the programmable processor can be a special-purpose or general-purpose programmable processor, which can receive data and instructions from a storage system, at least one input device, and at least one output device, and transmit the data and instructions to the storage system, the at least one input device, and the at least one output device.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combinations thereof.

To provide interaction with a user, the systems and techniques described herein may be implemented on a computer having: a display apparatus (for example, a cathode ray tube (CRT) or liquid crystal display (LCD) monitor) for displaying information to a user; and a keyboard and a pointing apparatus (for example, a mouse or a trackball) through which a user can provide input to the computer. Other kinds of apparatuses may also be used to provide interaction with the user; for example, the feedback provided to the user can be any form of sensory feedback (such as visual feedback, auditory feedback, or tactile feedback); and additionally, an input from the user may be received in any form (including acoustic input, voice input, or tactile input).

The systems and techniques described herein may be implemented on a computing system that includes back-end components (e.g., as a data server), or a computing system that includes middleware components (e.g., an application server), or a computing system that includes front-end components (e.g., a user computer having a graphical user interface or a web browser through which a user can interact with the embodiments of the systems and techniques described herein), or a computing system including any combination of such back-end components, middleware components, or front-end components. The components of the system may be mutually connected through digital data communication (for example, a communication network) in any form or medium. An example of the communication network includes: a local area network (LAN), a wide area network (WAN), and the Internet.

The computer system may include a client terminal and a server. The client terminal and the server are generally remote from each other and usually interact through a communication network. A relationship between the client terminal and the server is generated by computer programs that run on corresponding computers and have a client terminal-server relationship with each other.

It is to be understood that steps may be reordered, added, or deleted using the various forms of processes shown above. For example, the steps recorded in the present disclosure may be performed in parallel, may be performed sequentially, or may be performed in different orders as long as the desired results of the technical solution disclosed by the present disclosure are achieved, and there is no restriction herein.

The above specific embodiments do not constitute a limitation to the protection scope of the present disclosure. It will be apparent to those skilled in the art that various modifications, combinations, sub-combinations, and substitutions may be performed according to design requirements and other factors. Any modifications, equivalent replacements, and improvements made within the spirit and principles of the present disclosure shall be included in the scope of protection of the present disclosure.

What is claimed is:

1. A method comprising:
determining a distribution of hidden variables in a variational language model of a question-answer system based on a query in a training data set;
generating a plurality of answers for the query using the variational language model based on a plurality of hidden variables randomly sampled from the distribution;
determining reward scores for the plurality of answers using a reward model; and
updating the variational language model based on the query and the best answer with the highest reward score among the plurality of answers.

2. The method according to claim 1, wherein the hidden variables have a Gaussian distribution, and the determining distribution of hidden variables in the variational language model comprises:
inputting the query to the variational language model to acquire a mean and a variance of the Gaussian distribution from the variational language model.

3. The method according to claim 1, further comprising performing supervised pre-training on the variational language model, wherein the pre-training comprises:
defining a prior distribution of the hidden variables relative to the query and a conditional distribution of the answers relative to the query and the hidden variables;
defining a joint distribution of the answers and the hidden variables relative to the query based on the prior distribution and the conditional distribution;
determining a posterior probability of the hidden variables relative to the query and the answers; and
training the variational language model by maximizing an evidence lower bound, the evidence lower bound being calculated based on the joint distribution, the prior distribution, the conditional distribution, and the posterior probability.

4. The method according to claim 3, wherein the posterior probability has a Gaussian distribution, and the determining a posterior probability of the hidden variables relative to the query and the answers comprises:
inputting the query and the answers to a variational reasoning network to determine a mean and a variance of the Gaussian distribution of the posterior probability, the variational reasoning network being contained in the variational language model or being a separate network.

5. The method according to claim 1, wherein the generating a plurality of answers for the query using the variational language model comprises:
acquiring a hidden variable by randomly sampling from the distribution; and
generating current answer characters using the variational language model based on the hidden variable, answer characters already generated by the variational language model, and the query, so as to acquire one of the plurality of answers.

6. The method according to claim 1, wherein the generating a plurality of answers for the query using the variational language model comprises:
generating the plurality of answers for the query using a beam search with a diversity penalty function.

7. The method according to claim 1, wherein the reward model is trained by reinforcement learning based on human feedback, and the human feedback measures a quality of the answers.

8. The method according to claim 1, wherein the updating the variational language model comprises: performing the following actions at least once:
updating the variational language model based on a first optimization objective, the first optimization objective being defined as an expectation of a reward function of the reward model for the query and the best answer; and
updating the variational language model based on a second optimization objective, the second optimization objective being defined as an expectation of a difference between the reward function and a reference function.

9. The method according to claim 8, wherein the reference function is used for estimating an expected reward score for the query, and the reference function is achieved by sharing parameters with the reward model or a separate network model.

10. An electronic device, comprising:
at least one processor; and
a memory coupled to the at least one processor and having instructions stored therein, wherein the instructions, when executed by the at least one processor, cause the electronic device to perform actions comprising:
determining a distribution of hidden variables in a variational language model of a question-answer system based on a query in a training data set;
generating a plurality of answers for the query using the variational language model based on a plurality of hidden variables randomly sampled from the distribution;
determining reward scores for the plurality of answers using a reward model; and
updating the variational language model based on the query and the best answer with the highest reward score among the plurality of answers.

11. The electronic device according to claim 10, wherein the hidden variables have a Gaussian distribution, and the determining the distribution of hidden variables in the variational language model comprises:
inputting the query to the variational language model to acquire a mean and a variance of the Gaussian distribution from the variational language model.

12. The electronic device according to claim 10, wherein the actions further comprise performing supervised pre-training on the variational language model, and wherein the pre-training comprises:
defining a prior distribution of the hidden variables relative to the query and a conditional distribution of the answers relative to the query and the hidden variables;
defining a joint distribution of the answers and the hidden variables relative to the query based on the prior distribution and the conditional distribution;
determining a posterior probability of the hidden variables relative to the query and the answers; and
training the variational language model by maximizing an evidence lower bound, the evidence lower bound being calculated based on the joint distribution, the prior distribution, the conditional distribution, and the posterior probability.

13. The electronic device according to claim 12, wherein the posterior probability has a Gaussian distribution, and the determining a posterior probability of the hidden variables relative to the query and the answers comprises:
inputting the query and the answers to a variational reasoning network to determine a mean and a variance of the Gaussian distribution of the posterior probability, the variational reasoning network being contained in the variational language model or being a separate network.

14. The electronic device according to claim 10, wherein the generating a plurality of answers for the query using the variational language model comprises:
acquiring a hidden variable by randomly sampling from the distribution; and
generating current answer characters using the variational language model based on the hidden variable, answer characters already generated by the variational language model, and the query, so as to acquire one of the plurality of answers.

15. The electronic device according to claim 10, wherein the generating a plurality of answers for the query using the variational language model comprises:
generating the plurality of answers for the query using a beam search with a diversity penalty function.

16. The electronic device according to claim 10, wherein the reward model is trained by reinforcement learning based on human feedback, and the human feedback measures a quality of the answers.

17. The electronic device according to claim 10, wherein the updating the variational language model comprises: performing the following actions at least once:
updating the variational language model based on a first optimization objective, the first optimization objective being defined as an expectation of a reward function of the reward model for the query and the best answer; and
updating the variational language model based on a second optimization objective, the second optimization objective being defined as an expectation of a difference between the reward function and a reference function.

18. The electronic device according to claim 17, wherein the reference function is used for estimating an expected reward score for the query, and the reference function is achieved by sharing parameters with the reward model or a separate network model.

19. A non-transitory computer-readable storage medium having machine-executable instructions stored thereon, wherein the machine-executable instructions, when executed by a machine, cause the machine to perform the method of claim 1.

20. A computer program product, the computer program product being tangibly stored on a non-transitory computer-readable medium and comprising machine-executable instructions, wherein the machine-executable instructions, when executed by a machine, cause the machine to perform actions comprising:
determining a distribution of hidden variables in a variational language model of a question-answer system based on a query in a training data set;
generating a plurality of answers for the query using the variational language model based on a plurality of hidden variables randomly sampled from the distribution;
determining reward scores for the plurality of answers using a reward model; and
updating the variational language model based on the query and the best answer with the highest reward score among the plurality of answers.
